(19) United States
(12) Patent Application Publication
(10) Pub. No.: US 2014/0073341 A1
(43) Pub. Date: Mar. 13, 2014

(54) RADIO BASE STATION APPARATUS, MOBILE TERMINAL APPARATUS, RADIO COMMUNICATION METHOD AND RADIO COMMUNICATION SYSTEM

(71) Applicants: Satoshi Nagata, Tokyo (JP); Tetsushi Abe, Tokyo (JP); Yoshihisa Kishiyama, Tokyo (JP); Jianchi Zhu, Beijing (CN); Xiang Yun, Beijing (CN)

(72) Inventors: Satoshi Nagata, Tokyo (JP); Tetsushi Abe, Tokyo (JP); Yoshihisa Kishiyama, Tokyo (JP); Jianchi Zhu, Beijing (CN); Xiang Yun, Beijing (CN)

(73) Assignee: NTT DOCOMO, INC., Tokyo (JP)

(21) Appl. No.: 14/116,375

(22) PCT Filed: May 10, 2012
(86) PCT No.: PCT/JP2012/062002

§ 371 Date: Nov. 20, 2013

(30) Foreign Application Priority Data
May 11, 2011 (JP) 2011-106413

(51) Int. Cl. H04W 52/38; H04L 5/00

(52) U.S. Cl. CPC H04W 52/38; H04L 5/0035
USPC 455/452.1

(57) ABSTRACT

The present invention is designated to improve received quality in a mobile terminal apparatus when coordinated multiple-point transmission (CoMP)—in particular, DCS-CoMP—is adopted. With the radio communication method of the present invention, when dynamic cell selection-type coordinated multiple-point transmission is adopted, a radio base station apparatus increases transmission power in radio resources to transmit to a mobile terminal apparatus, transmits the increased transmission power to the mobile terminal apparatus as transmission power information and performs dynamic cell selection-type coordinated multiple-point transmission at the increased transmission power.

### TECHNICAL FIELD

The present invention relates to a radio base station apparatus, a mobile terminal apparatus, a radio communication method and a radio communication system. More particularly, the present invention relates to a radio base station apparatus, a mobile terminal apparatus, a radio communication method and a radio communication system for performing coordinated multiple-point (CoMP) transmission/reception.

### BACKGROUND ART

In the UMTS (Universal Mobile Telecommunications System) network, for the purposes of improving spectral efficiency and improving the data rates, system features based on W-CDMA (Wideband Code Division Multiple Access) are maximized by adopting HSDPA (High Speed Downlink Packet Access) and HSUPA (High Speed Uplink Packet Access). For this UMTS network, for the purposes of further increasing high-speed data rates, providing low delay and so on, long-term evolution (LTE) has been under study (non-patent literature 1).

In the third-generation system, it is possible to achieve a transmission rate of maximum approximately 2 Mbps on the downlink by using a fixed band of approximately 5 MHz. Meanwhile, in a system of the LTE scheme, it is possible to achieve a transmission rate of about maximum 300 Mbps on the downlink and about 75 Mbps on the uplink by using a variable band which ranges from 1.4 MHz to 20 MHz. Furthermore, in the UMTS network, for the purpose of achieving further broadbandization and higher speed, successor systems of LTE have been under study as well (for example, LTE-Advanced (LTE-A)). For example, in LTE-A, there is a plan to expand the maximum system band for LTE specifications, which is 20 MHz, to approximately 100 MHz.

As a promising technique for further improving the system performance of the Rel-8 LTE system, there is inter-cell orthogonalization. In the LTE systems of Rel-10 (LTE-A system) and later versions, intra-cell orthogonalization is made possible by orthogonal multiple access on both the uplink and the downlink. That is to say, on the downlink, orthogonalization is provided between mobile terminal apparatuses (UEs: User Equipment) in the frequency domain. However, between cells, like in W-CDMA, interference randomization by repeating one-cell frequency is fundamental. In the 3GPP (3rd Generation Partnership Project), coordinated multiple-point transmission/reception (CoMP) is under study as a technique for realizing inter-cell orthogonalization. In CoMP transmission/reception, a plurality of cells coordinate and perform signal processing for transmission and reception for one mobile terminal apparatus (UE) or a plurality of mobile terminal apparatuses (UEs). To be more specific, on the downlink, joint transmission (JT), dynamic cell selection (DCS) and so are under study (Joint Processing (JP)-CoMP).

### CITATION LIST

### Non-Patent Literature

Non-Patent Literature 1: 3GPP, TR 25.912 (V7.1.0), “Feasibility Study for Evolved UTRA and UTRAN,” September 2006

### SUMMARY OF THE INVENTION

### Technical Problem

When DCS-CoMP is adopted in a radio communication system, data is transmitted from one of a plurality of cells to a mobile terminal apparatus. That is to say, in DCS-CoMP, while data is transmitted from the radio base station apparatus of one cell, data is not transmitted from the radio base station apparatuses of the other cells. In this way, when DCS-CoMP is adopted, there is a threat that, since data is transmitted from a single cell, received quality becomes lower in mobile terminal apparatuses (especially in cell-edge mobile terminal apparatuses).

The present invention has been made in view of the above, and it is therefore an object of the present invention to provide a radio base station apparatus, a mobile terminal apparatus, a radio communication method and a radio communication system which can improve received quality in mobile terminal apparatuses when coordinated multiple-point transmission (CoMP)—in particular, DCS-CoMP—is adopted.

### Solution to Problem

A radio base station apparatus according to the present invention has: a power changing section configured to, when dynamic cell selection-type coordinated multiple-point transmission is adopted, increase transmission power in radio resources to transmit to a mobile terminal apparatus; and a transmission section configured to transmit the increased transmission power to the mobile terminal apparatus as transmission power information, and also perform dynamic cell selection-type coordinated multiple-point transmission at the increased transmission power.

A mobile terminal apparatus according to the present invention has: a receiving section configured to, when dynamic cell selection-type coordinated multiple-point transmission is adopted, receive transmission power information representing the increased transmission power; and a demodulation section configured to demodulate a signal received by dynamic cell selection-type coordinated multiple-point reception.

A radio communication method according to the present invention includes the steps of: in a radio base station apparatus: when dynamic cell selection-type coordinated multiple-point transmission is adopted, increasing transmission power in radio resources to transmit to a mobile terminal apparatus; transmitting the increased transmission power to the mobile terminal apparatus as transmission power information; and performing dynamic cell selection-type coordinated multiple-point transmission at the increased transmission power; and, in the mobile terminal apparatus: receiving the transmission power information; and demodulating a signal received by dynamic cell selection-type coordinated multiple-point reception.

A radio communication system according to the present invention includes: a radio base station apparatus comprising: a power changing section configured to, when dynamic cell selection-type coordinated multiple-point transmission is adopted, increases transmission power in radio resources to transmit to a mobile terminal apparatus; and a transmission section configured to transmit the increased transmission power to the mobile terminal apparatus as transmission power information, and also perform dynamic cell selection-type coordinated multiple-point to transmission at the increased transmission power; and a mobile terminal apparatus comprising: a receiving section configured to receive the transmission power information; and a demodulation section configured to demodulate a signal received by dynamic cell selection-type coordinated multiple-point reception.

### Technical Advantage of the Invention

According to the present invention, when dynamic cell selection-type coordinated multiple-point transmission is adopted, a radio base station apparatus increases transmission power in radio resources to transmit to a mobile terminal apparatus, and transmits the increased transmission power to the mobile terminal apparatus as transmission power information, so that it is possible to improve received quality in the mobile terminal apparatus when coordinated multiple-point transmission (CoMP)—in particular, DCS-CoMP—is adopted.

### BRIEF DESCRIPTION OF DRAWINGS

FIG. 1 is a diagram to explain DCS-CoMP;

FIG. 2 is a diagram to explain change of transmission power according to the radio communication method of the present invention;

FIG. 3 is a diagram to explain change of transmission power according to the radio communication method of the present invention;

FIG. 4 is a diagram to explain the first method of the radio communication method according to the present invention;

FIG. 5 is a diagram to explain a second method of the radio communication method according to the present invention;

FIG. 6 is a diagram to explain a configuration of a radio communication system;

FIG. 7 is a diagram to explain an overall configuration of a radio base station apparatus;

FIG. 8 is a functional block diagram corresponding to the radio communication method of the present invention by a radio base station apparatus;

FIG. 9 is a diagram to explain an overall configuration of a mobile terminal apparatus; and

FIG. 10 is a functional block diagram corresponding to the radio communication method of the present invention by a mobile terminal apparatus.

### DESCRIPTION OF EMBODIMENTS

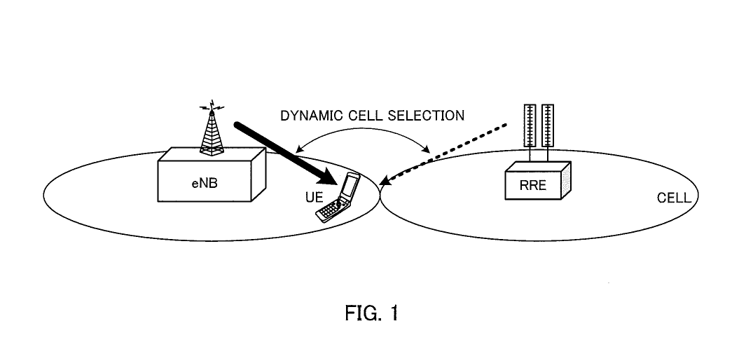

First, downlink CoMP transmission will be described. Downlink CoMP transmission includes coordinated scheduling/coordinated beamforming (CS/CB), and joint processing. Coordinated scheduling/coordinated beamforming is a method of transmitting from only one cell to one UE, and is a method of allocating radio resources in the frequency/space domain taking into account interference from other cells and interference against other cells. On the other hand, joint processing refers to simultaneous transmission by a plurality of cells adopting precoding, and includes joint transmission to transmit from a plurality of cells to one UE, and dynamic cell selection to select cells instantaneously as shown in FIG. 1.

As a configuration to realize CoMP transmission, there is a configuration (centralized control based on a remote radio equipment configuration) to include a radio base station apparatus eNB and a plurality of remote radio equipment (RREs) that are connected with the radio base station apparatus eNB by an optical remote configuration (optical fiber). Besides, there is a configuration of a radio base station apparatus eNB (autonomous distributed control based on an independent base station configuration). The present invention is equally applicable to any of the above configurations.

In centralized control, remote radio equipment is controlled in a centralized fashion in a radio base station apparatus eNB. In the RRE configuration, the radio base station apparatus eNB (centralized base station) to perform baseband signal processing and control for a plurality of RREs, and each cell—that is, RRE—are connected by baseband signals using optical fiber, so that it is possible to execute radio resource control between the cells in the centralized base station altogether. On the other hand, in autonomous distributed control, radio resource allocation control such as scheduling is performed in each of a plurality of radio base station apparatus eNBs (or RREs). In this case, by using the X2 interface between the radio base station apparatuses, radio resource allocation information such as timing information and scheduling is transmitted to one of the radio base station apparatuses when necessary, thereby coordinating between the cells.

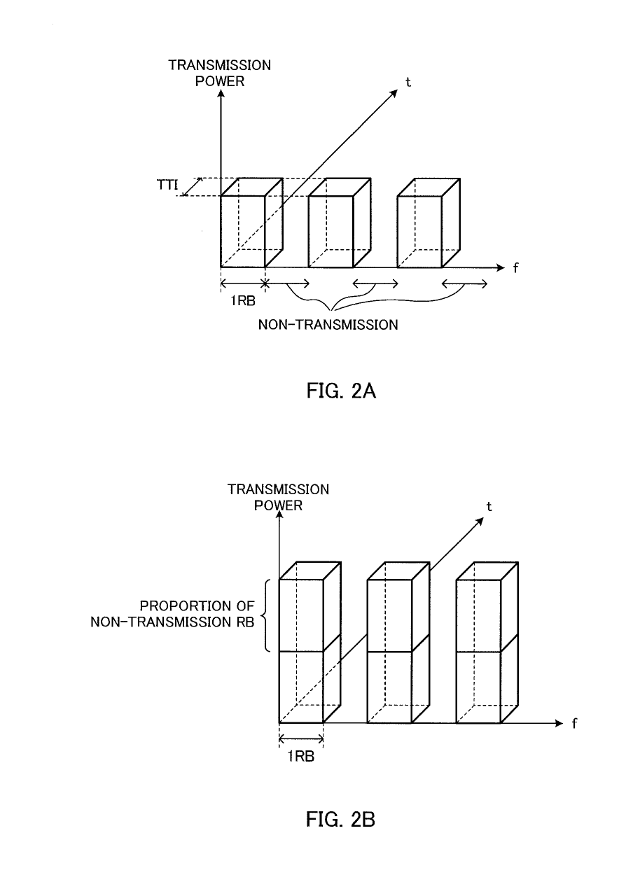

When DCS-CoMP is adopted, data is transmitted from one of a plurality of cells—for example, from one arbitrary cell as shown in FIG. 1—to the same mobile terminal apparatus. In this way, when DCS-CoMP is adopted, data is transmitted from a single cell. That is to say, as shown in FIG. 2A, in the radio base station apparatus of one cell, there are radio resources in which transmission is made to a mobile terminal apparatus and radio resources in which no transmission is made to the mobile terminal apparatus (non-transmission resources in the drawing). By transmitting data from a single cell in this way, interference components decrease, and the received SIR (Signal to Interference Ratio) increases at the mobile terminal apparatus.

In this way, in DCS-CoMP, interference is reduced by providing radio resources in which no transmission is made to a mobile terminal apparatus, in radio resource units. Consequently, as for the transmission power in the same TTI (Transmission Time Interval), it is possible to use extra transmission power for the non-transmission radio resources. The present inventors have focused on this point, and arrived at the present invention upon finding out that, as shown in FIG. 2B, in DCS-CoMP transmission, it is possible to further improve the received quality in a mobile terminal apparatus by using the proportion of transmission power for non-transmission radio resource in the same TTI for the transmission power of radio resources to transmit to the mobile terminal apparatus.

That is to say, a gist of the present invention is that, when dynamic cell selection-type coordinated multiple-point transmission is adopted, a radio base station apparatus increases transmission power in radio resources to transmit to a mobile terminal apparatus and transmits the increased transmission power to the mobile terminal apparatus as transmission power information, so that the received quality in the mobile terminal apparatus is further improved when CoMP—in particular, DCS-CoMP—is adopted.

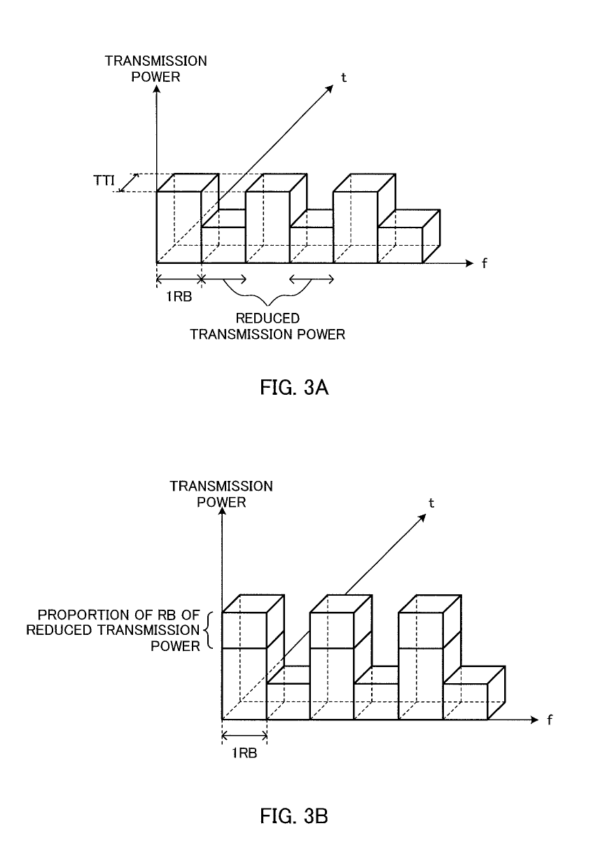

The radio resources here refer to, for example, RBs (resource blocks) in the same TTI. Consequently, radio resources to make transmission to a mobile terminal apparatus and radio resources to make no transmission to the mobile terminal apparatus refer to, for example, RBs in the same TTI. Note that, although a case is shown with FIG. 2A and FIG. 2B (or the same applies to FIG. 3A and FIG. 3B) where radio resources (RBs) to make transmission to a mobile terminal apparatus and radio resources (RBs) to make no transmission to the mobile terminal apparatus are repeated alternately, the present invention is by no means limited to this, and it is equally possible to make transmission and not make transmission to a mobile terminal apparatus over a plurality of radio resources (RBs).

With the present invention, as shown in FIG. 3A, when there are radio resources to make transmission to a mobile terminal apparatus and radio resources to lower the transmission power for the mobile terminal apparatus (resources of reduced transmission power in the drawing), as shown in FIG. 3B, the proportion of transmission power for the radio resources of reduced transmission power in the same TTI may be used for the transmission power of radio resources to make transmission to the mobile terminal apparatus. Note that the transmission power to increase may be the entire transmission power of non-transmission radio resources and radio resources of reduced transmission power (twice in FIG. 2B and 1.5 times in FIG. 3B), or may be part of the transmission power of non-transmission radio resources and radio resource of reduced transmission power (at least part of the transmission power).

When DCS-CoMP is adopted, information to the effect that transmission power is going to be increased (transmission power information) is transmitted from a radio base station apparatus to a mobile terminal apparatus. In this case, as for the method of reporting the transmission power information, there are a method of transmitting to a mobile terminal apparatus semi-statically by higher layer signaling and a method of transmitting to a mobile terminal apparatus dynamically by downlink control signals (DCI).

When transmission power information is included in DCI, for example, bit information is included in DCI (Downlink Control Information) and reported dynamically. The mobile terminal apparatus has, for example, a table (a table in which the bit information to be included in DCI and the proportions of increased transmission power are associated with each other), and recognizes the proportion of increased transmission power from the bit information reported by DCI. In this case, the proportion of increased transmission power may be defined in terms of how many times more transmission power is used compared to when CoMP is not adopted, or may be defined in a more specific quantity of increase (dB).

With the present invention, signals that are transmitted with changed transmission power when DCS-CoMP is adopted may include the PDSCH (Physical Downlink Shared Channel) signal and the DM-RS (Demodulation Reference Signal).

A mobile terminal apparatus receives signals with changed transmission power when DCS-CoMP is adopted. Consequently, the mobile terminal apparatus has to recognize whether or not DCS-CoMP is adopted. As for the method of recognizing whether or not CoMP is adopted, there are the following two methods.

(First Method)

This is a method of identifying whether or not CoMP is adopted based on a criterion on the mobile terminal apparatus side. According to this method, a mobile terminal apparatus measures the received power of each neighboring cell reported from the serving cell, and determines CoMP candidate cells from the measurement results of the received power of the neighboring cells. The mobile terminal apparatus feeds back feedback information (feedback information in CoMP mode) with respect to all the CoMP candidate cells, assuming that these CoMP candidate cells can be coordinated cells, to the radio base station apparatus.

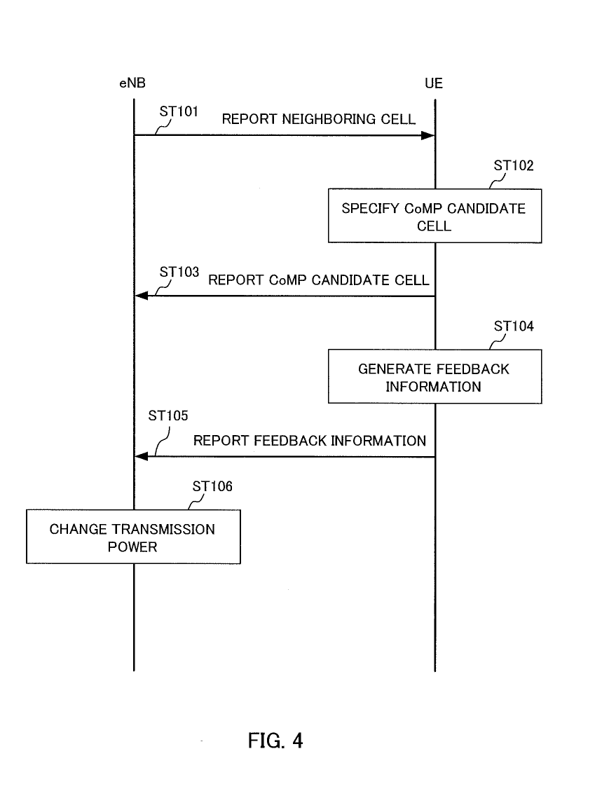

This method will be described using FIG. 4. First, from the radio base station apparatus (eNB) of the serving cell, information about neighboring cells (neighboring cell information) is reported semi-statically (ST 101). Next, a mobile terminal apparatus specifies CoMP candidate cells using the neighboring cell information (ST 102). To be more specific, the mobile terminal apparatus measures the received power of the signal from the serving cell and the received power of the signals from a plurality of neighboring cells, calculates the differences between the measurement result (received power) of the serving cell and the measurement results (received power) of the neighboring cells, and specifies neighboring cells where that difference is equal to lower than a predetermined threshold value as CoMP candidate cells. In this way, when there are CoMP candidate cells, the mobile terminal apparatus recognizes that DCS-CoMP is adopted. The mobile terminal apparatus reports this CoMP candidate cell information to the radio base station apparatus of the serving cell by higher layer signaling or by the PDCCH (ST 103).

Next, the mobile terminal apparatus generates feedback information for each specified CoMP candidate cell (ST 104). The feedback information here refers to the CQI (Channel Quality Indicator), PMI (Precoding Matrix Indicator), RI (Rank Indicator) and so on. The mobile terminal apparatus reports this feedback information to the radio base station apparatus of the serving cell by the PUCCH (Physical Uplink Control Channel) (ST 105). The radio base station apparatus changes (increases) transmission power, as shown in FIG. 2B or FIG. 3B, when DCS-CoMP is adopted (ST 106). When DCS-CoMP is adopted, transmission power information to indicate changes of transmission power is reported from the radio base station apparatus to the mobile terminal apparatus by higher layer signaling or by downlink control information.

Although, in FIG. 4, transmission power is changed in the radio base station apparatus after feedback information is reported, the present invention is by no means limited to this, and it is equally possible to change transmission power in the radio base station apparatus before feedback information is reported.

(Second Method)

This is a method of identifying whether or not CoMP is adopted based on a criterion on the radio base station apparatus side. According to this method, a mobile terminal apparatus measures the received power of each neighboring cell reported from the serving cell, specifies CoMP candidate cells from the measurement results of the received power of the neighboring cells, and reports information about the CoMP candidate cells to the radio base station apparatus, and the radio base station apparatus determines CoMP cells from the CoMP candidate cells and reports information about the CoMP cells to the mobile terminal apparatus. The mobile terminal apparatus feeds back feedback information (feedback information in CoMP mode) with respect to these CoMP cells, to the radio base station apparatus.

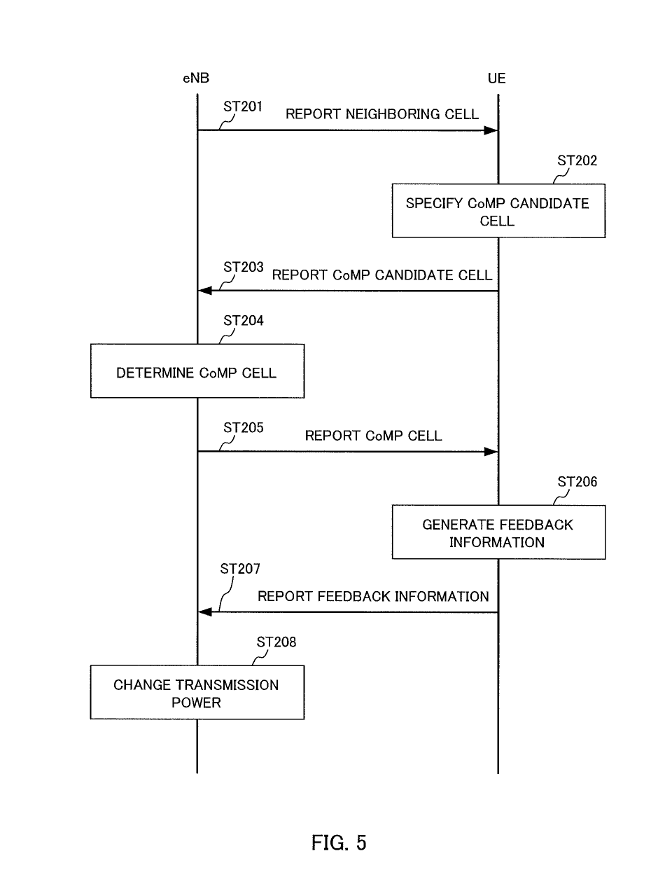

This method will be described using FIG. 5. First, from the radio base station apparatus (eNB) of the serving cell, information about neighboring cells (neighboring cell information) is reported semi-statically (ST 201). Next, a mobile terminal apparatus specifies CoMP candidate cells using the neighboring cell information (ST 202). To be more specific, the mobile terminal apparatus measures the received power of the signal from the serving cell and the received power of the signals from a plurality of neighboring cells, calculates the differences between the measurement result (received power) of the serving cell and the measurement results (received power) of the neighboring cells, and specifies neighboring cells where that difference is equal to lower than a predetermined threshold value as CoMP candidate cells. The mobile terminal apparatus reports this CoMP candidate cell information to the radio base station apparatus of the serving cell by higher layer signaling or by the PDCCH (ST 203).

Next, the radio base station apparatus determines CoMP cells from the CoMP candidate cell information reported (ST 204). Then, the radio base station apparatus reports information about the CoMP cells (CoMP cell information) to the mobile terminal apparatus semi-statically (ST 205). In this way, when CoMP cells are reported, the mobile terminal apparatus recognizes that DCS-CoMP is adopted. Next, the mobile terminal apparatus generates feedback information for each reported CoMP cell (ST 206). The feedback information here refers to the CQI, PMI, RI and so on. The mobile terminal apparatus reports this feedback information to the radio base station apparatus of the serving cell by the PUCCH (ST 207). The radio base station apparatus changes (increases) transmission power, as shown in FIG. 2B or FIG. 3B, when DCS-CoMP is adopted (ST 208). When DCS-CoMP is adopted, transmission power information to indicate changes of transmission power is reported from the radio base station apparatus to the mobile terminal apparatus by higher layer signaling or by downlink control information.

Although, in FIG. 5, transmission power is changed in the radio base station apparatus after feedback information is reported, the present invention is by no means limited to this, and it is equally possible to change transmission power in the radio base station apparatus before feedback information is reported.

In this way, according to the present invention, when DCS-CoMP is adopted, transmission power is increased in radio resources to transmit to a mobile terminal apparatus. Consequently, interference is reduce by making no transmission or by reducing transmission power in radio resource (RB) units, and also transmission power is increased when transmitting signals, so that it is possible to further improve received quality in a mobile terminal apparatus.

Now, an embodiment of the present invention will be described below in detail with reference to the accompanying drawings. Here, a case of using a radio base station apparatus and a mobile terminal apparatus supporting the LTE-A system will be described.

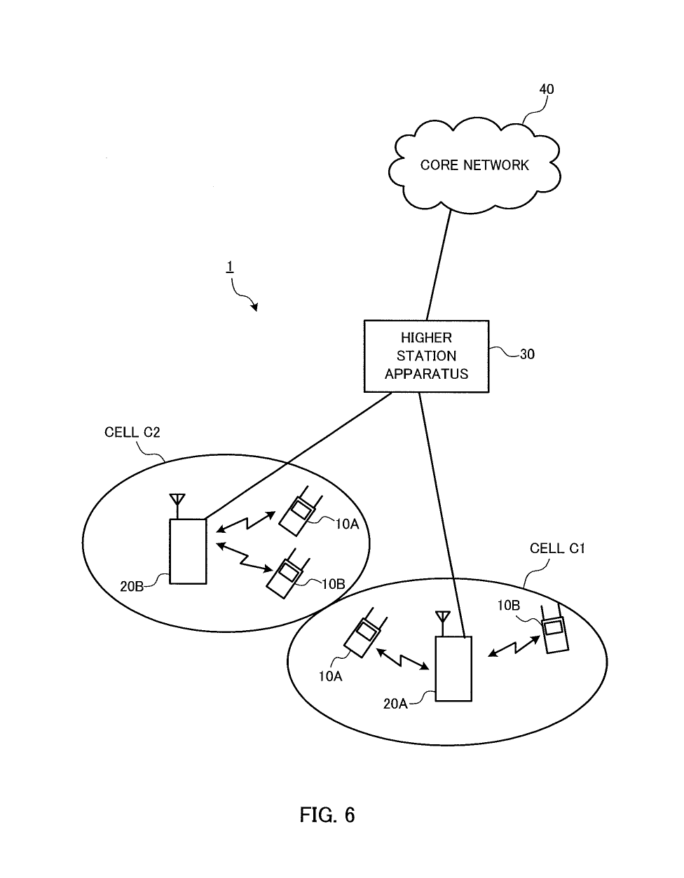

A radio communication system 1 having a mobile terminal apparatus (UE: User Equipment) 10 and a radio base station apparatus (eNodeB) 20 according to an embodiment of the present invention will be described with reference to FIG. 6. FIG. 6 is a diagram to explain the configuration of the radio communication system 1 having mobile terminal apparatuses 10 and radio base station apparatuses 20 according to the present invention. Note that the radio communication system 1 shown in FIG. 1 is a system to accommodate, for example, the LTE system or SUPER 3G. Also, this radio communication system 1 may be referred to as IMT-Advanced or may be referred to as 4G.

As shown in FIG. 6, the radio communication system 1 is configured to include radio base station apparatuses 20A and 20B and a plurality of mobile terminal apparatuses 10A and 10B that communicate with these radio base station apparatuses 20A and 20B. The radio base station apparatuses 20A and 20B are each connected with a higher station apparatus 30, and this higher station apparatus 30 is connected with a core network 40. The mobile terminal apparatuses 10A and 10B communicate with the radio base station apparatus 20A in a cell C1 and communicate with the radio base station apparatus 20B in a cell C2. Note that the higher station apparatus 30 includes, for example, an access gateway apparatus, a radio network controller (RNC), a mobility management entity (MME) and so on, but is by no means limited to these.

The mobile terminal apparatuses (10A and 10B) have the same configuration, functions and state, so that the following description will be given simply with respect to “mobile terminal apparatus 10,” unless specified otherwise. Also, although the mobile terminal apparatuses 10A and 10B will be described to perform radio communication with the base station apparatuses 20A and 20B, for ease of explanation, more generally, user apparatuses (UE: User Equipment) including mobile terminal apparatuses and fixed terminal apparatuses may be used as well.

In the radio communication system 1, as radio access schemes, OFDMA (Orthogonal Frequency Division Multiple Access) is applied to the downlink, and SC-FDMA (Single-Carrier Frequency-Division Multiple Access) is applied to the uplink. OFDMA is a multi-carrier transmission scheme to perform communication by dividing a frequency band into a plurality of narrow frequency bands (subcarriers) and mapping data to each subcarrier. SC-FDMA is a single carrier transmission scheme to reduce interference between terminals by dividing, per terminal, the system band into bands formed with one or continuous resource blocks, and allowing a plurality of terminals to use mutually different bands.

Here, communication channels in the LTE system will be described. The downlink communication channels include a PDSCH, which is used by the mobile terminal apparatuses 10A and 10B on a shared basis as a downlink data channel, and downlink L1/L2 control channels (PDCCH, PCFICH, PHICH). Transmission data and higher control information are transmitted by the PDSCH. Scheduling information for the PDSCH and the PUSCH and so on are transmitted by the PDCCH. The number of OFDM symbols to use for the PDCCH is transmitted by the PCFICH (Physical Control Format Indicator Channel). HARQ ACK/NACK for the PUSCH are transmitted by the PHICH (Physical Hybrid-ARQ Indicator Channel).

The uplink communication channels include a PUSCH (Physical Uplink Shared Channel), which is an uplink data channel that is used by each mobile terminal apparatus on a shared basis, and a PUCCH (Physical Uplink Control Channel), which is an uplink control channel. By means of this PUSCH, transmission data and higher control information are transmitted. Furthermore, downlink radio quality information (CQI), ACK/NACK, and so on are transmitted by the PUCCH.

In the radio communication system of the above configuration, when DCS-CoMP transmission is adopted, a radio base station apparatus increases transmission power in radio resources to transmit to a mobile terminal apparatus, transmits the increased transmission power to the mobile terminal apparatus as transmission power information and performs DCS-CoMP transmission at the increased transmission power. Meanwhile, the mobile terminal apparatus receives the transmission power information representing the increased transmission power, and demodulates signals received by DCS-CoMP reception.

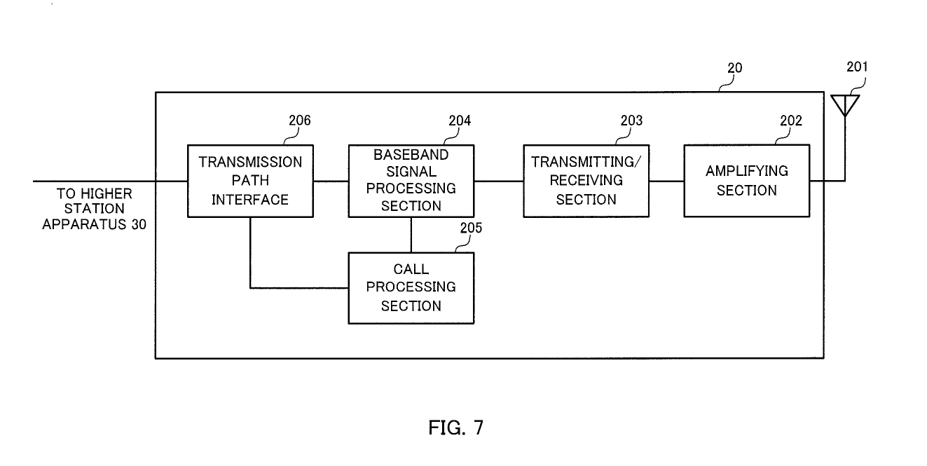

Now, referring to FIG. 7, an overall configuration of a radio base station apparatus according to the present embodiment will be explained. Note that the base station apparatuses 20A and 20B have the same configuration and therefore will be described simply as “base station apparatus 20.” Also, the mobile terminal apparatuses 10A and 10B have the same configuration and will be described simply as “mobile terminal apparatus 10.” The radio base station apparatus 20 has a transmitting/receiving antenna 201, an amplifying section 202, a transmitting/receiving section (reporting section) 203, a baseband signal processing section 204, a call processing section 205, and a transmission path interface 206. Transmission data to be transmitted from the radio base station apparatus 20 to the mobile terminal apparatus on the downlink is input from the higher station apparatus 30, into the baseband signal processing section 204, via the transmission path interface 206.

In the baseband signal processing section 204, the downlink data channel signal is subject to, for example, a PDCP layer process, division and coupling of transmission data, RLC (Radio Link Control) layer transmission processes such as an RLC retransmission control transmission process, MAC (Medium Access Control) retransmission control, including, for example, an HARQ transmission process, scheduling, transport format selection, channel coding, an inverse fast Fourier transform (IFFT) process, and a precoding process. Furthermore, as for the signal of the physical downlink control channel, which is a downlink control channel, transmission processes such as channel coding and an inverse fast Fourier transform are performed.

Also, the baseband signal processing section 204 reports control information for allowing each mobile terminal apparatus 10 to communicate with the radio base station apparatus 20, to the mobile terminal apparatuses 10 connected to the same cell, by a broadcast channel. The information for allowing communication in the cell includes, for example, the uplink or downlink system bandwidth, identification information of a root sequence (root sequence index) for generating random access preamble signals in the PRACH (Physical Random Access Channel), and so on.

A baseband signal that is output from the baseband signal processing section 204 is converted into a radio frequency band in the transmitting/receiving section 203. The amplifying section 202 amplifies the radio frequency signal having been subjected to frequency conversion, and outputs the result to the transmitting/receiving antenna 201. Note that the transmitting/receiving section 203 constitutes a receiving section to receive CoMP candidate cell information, and constitutes a transmitting section to transmit transmission power information, CoMP cell information and neighboring cell information and also perform CoMP transmission of transmission signals.

Meanwhile, as for a signal to be transmitted from the mobile terminal apparatus 10 to the radio base station apparatus 20 on the uplink, the radio frequency signal received in the transmitting/receiving antenna 201 is amplified in the amplifying section 202, converted into a baseband signal by frequency conversion in the transmitting/receiving section 203, and input in the baseband signal processing section 204.

The baseband signal processing section 204 applies, to the transmission data included in the baseband signal received on the uplink, an FFT process, an IDFT process, error correction decoding, a MAC retransmission control receiving process, and RLC layer and PDCP layer receiving processes. The decoded signal is transferred to the higher station apparatus 30 through the transmission path interface 206.

The call processing section 205 performs call processing such as setting up and releasing communication channels, manages the state of the radio base station apparatus 20 and manages the radio resources.

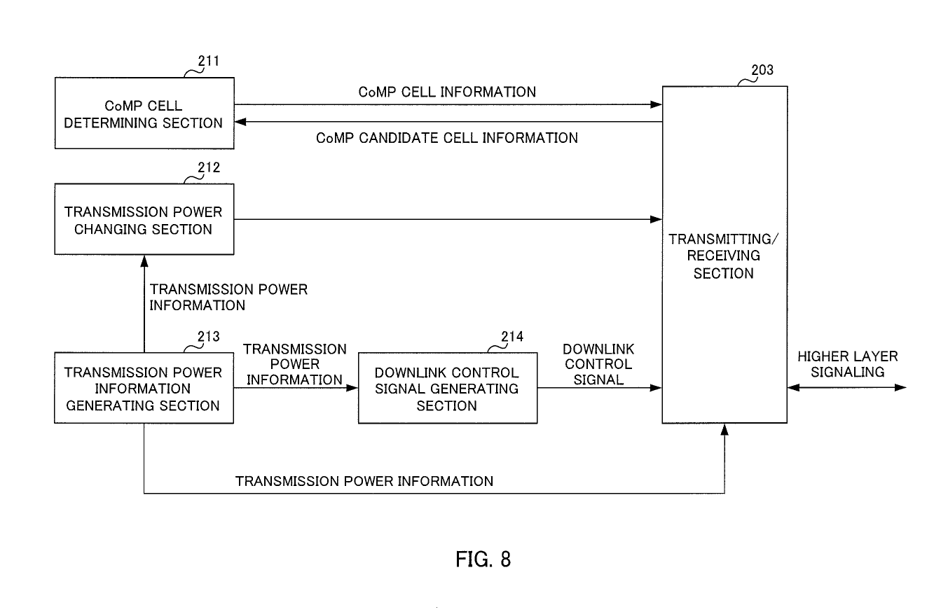

The function blocks of the radio base station apparatus 20 will be described with reference to FIG. 8. The function blocks of FIG. 8 are primarily the processing content of the baseband processing section. Also, the function blocks shown in FIG. 8 are simplified to explain the present invention, and assumed to have the configurations which a baseband processing section normally has.

As shown in FIG. 8, the radio base station apparatus 20 has a CoMP cell determining section 211, a transmission power changing section 212, a transmission power information generating section 213, a downlink control signal generating section 214, and a transmitting/receiving section 203. When DCS-CoMP transmission is applied, this radio base station apparatus 20 increases transmission power in radio resources to transmit to the mobile terminal apparatus, transmits the increased transmission power to the mobile terminal apparatus as transmission power information, and performs DCS-CoMP transmission at the increased transmission power.

The CoMP cell determining section 211 determines CoMP cells based on the CoMP candidate cell information reported from the mobile terminal apparatus (second method). The CoMP cell determining section 211 outputs information about the determined CoMP cells (CoMP information) to the transmitting/receiving section 203. The criterion for determining CoMP cells from CoMP candidate cell information (CoMP candidate cell indices) is not particularly limited.

The transmission power changing section 212 changes transmission power for transmission to a CoMP mobile terminal apparatus, based on transmission power information, when DCS-CoMP is adopted. For example, when DCS-CoMP is adopted, the transmission power changing section 212 changes transmission power as shown in FIG. 2B or FIG. 3B, based on transmission power information. The transmission power information is output from the transmission power information generating section 213.

The transmission power information generating section 213 generates information (transmission power information) as to how much transmission power is changed (increased). The proportion of increased transmission power may be defined in terms of how many times more transmission power is used compared to when CoMP is not adopted, or may be defined in a more specific quantity of increase (dB). The transmission power information generating section 213 outputs the transmission power information to the transmission power changing section 212. Also, the transmission power information generating section 213 outputs transmission power information to the transmitting/receiving section 203 in the event of the first method, and outputs transmission power information to the downlink control signal generating section 214 in the event of the second method.

The control signal generating section 214 generates a control signal including the transmission power information in DCI. With the second method, for example, the downlink control signal generating section 214 includes bits to represent transmission power information, in DCI, and generates a downlink control signal. Also, the downlink control signal generating section 214 outputs the generated downlink control signal (PDCCH signal) to the transmitting/receiving section 203.

The transmitting/receiving section 203 maps the CRS, DM-RS, CSI-RS and downlink control signal to resources and transmits these to the mobile terminal apparatus 10 as downlink signals. Note that the downlink signals include, besides the above signals, signals to be transmitted in a normal fashion as downlink signals. According to the first method, the transmitting/receiving section 203 transmits transmission power information to the mobile terminal apparatus semi-statically by higher layer signaling. Also, according to the second method, the transmitting/receiving section 203 transmits transmission power information to the mobile terminal apparatus dynamically by downlink control signals.

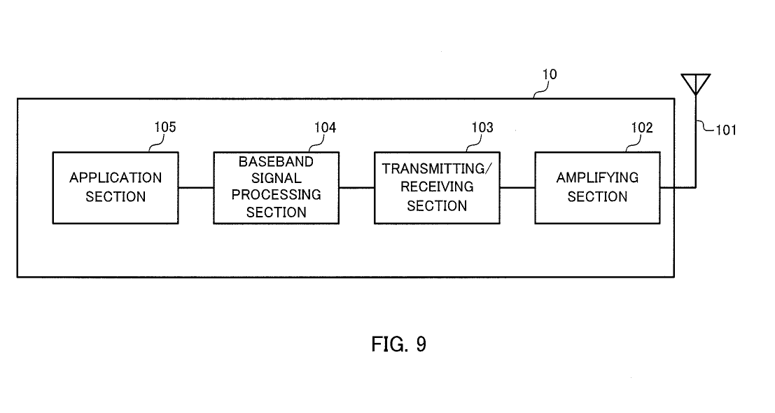

Next, an overall configuration of a mobile terminal apparatus according to the present embodiment will be described with reference to FIG. 9. An LTE terminal and an LTE-A terminal have the same hardware configurations in principle parts, and therefore will be described indiscriminately. A mobile terminal apparatus 10 has a transmitting/receiving antenna 101, an amplifying section 102, a transmitting/receiving section (receiving section) 103, a baseband signal processing section 104, and an application section 105. When DCS-CoMP transmission is adopted, this mobile terminal apparatus receives transmission power information, which represents the increased transmission power, and demodulates signals received by DCS-CoMP reception.

As for downlink data, a radio frequency signal received in the transmitting/receiving antenna 101 is amplified in the amplifying section 102, and subjected to frequency conversion and converted into a baseband signal in the transmitting/receiving section 103. This baseband signal is subjected to receiving processes such as an FFT process, error correction decoding and retransmission control, in the baseband signal processing section 104. In this downlink data, downlink transmission data is transferred to the application section 105. The application section 105 performs processes related to higher layers above the physical layer and the MAC layer. Also, in the downlink data, broadcast information is also transferred to the application section 105.

Meanwhile, uplink transmission data is input from the application section 105 to the baseband signal processing section 104. In the baseband signal processing section 104, a mapping process, a retransmission control (HARQ) transmission process, channel coding, a DFT process, and an IFFT process are performed. A baseband signal that is output from the baseband signal processing section 104 is converted into a radio frequency band in the transmitting/receiving section 103, and, after that, amplified in the amplifying section 102 and transmitted from the transmitting/receiving antenna 101.

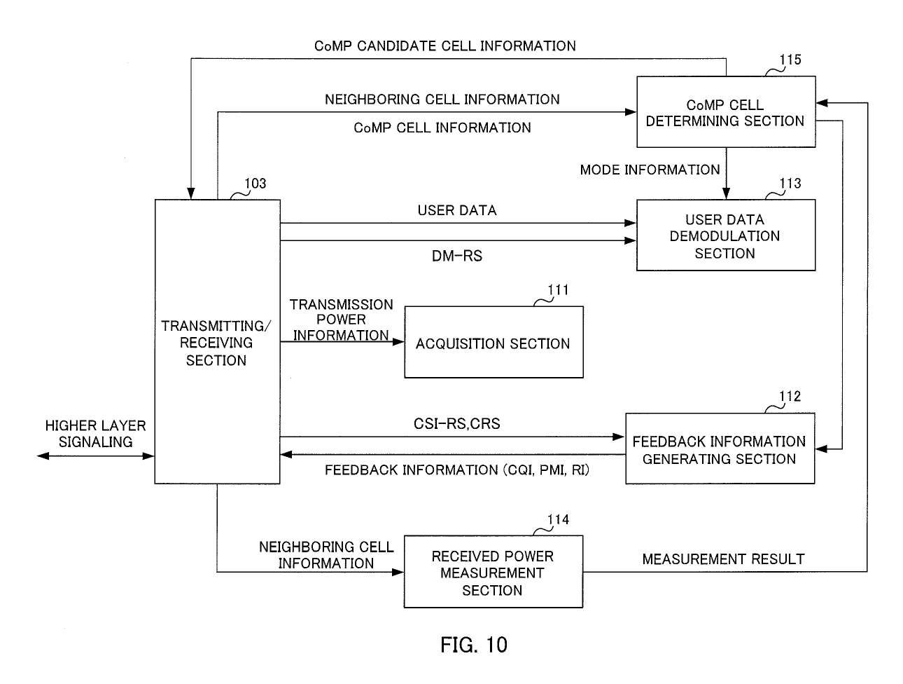

The functions blocks of the mobile terminal apparatus 10 will be described with reference to FIG. 10. The function blocks of FIG. 10 are primarily the processing content of the baseband processing section. Also, the function blocks shown in FIG. 10 are simplified to explain the present invention, and assumed to have the configurations which a baseband processing section normally has.

As shown in FIG. 10, the mobile terminal apparatus 10 has a transmitting/receiving section 103, an acquisition section 111, a feedback information generating section 112, a user data demodulation section 113, a received power measurement section 114, and a CoMP cell determining section 115.

The transmitting/receiving section 103 receives a downlink control signal (PDCCH signal) transmitted from the radio base station apparatus 20 and also receives a data channel signal (PDSCH signal: user data). The transmitting/receiving section 103 outputs the downlink control signal and transmission power information given by higher layer signaling, to the acquisition section 111. Also, the transmitting/receiving section 103 outputs the user data and the DM-RS to the user data demodulation section 113, and also outputs the CRS and CSI-RS to the feedback information generating section 112. Also, the transmitting/receiving section 103 constitutes a receiving section to receive neighboring cell information and CoMP cell information from the radio base station apparatus by higher layer signaling, and constitutes a transmitting section to transmit CoMP candidate cell information by higher layer signaling or by the PDCCH. Also, the transmitting/receiving section 103 transmits feedback information of the serving cell and feedback information of the CoMP cells or CoMP candidate cells, to the radio base station apparatus.

When transmission power information is transmitted by a downlink control signal, the acquisition section 111 analyzes the downlink control signal received in the transmitting/receiving section 103 and acquires the transmission power information. Also, when transmission power information is transmitted by higher layer signaling, the acquisition section 111 acquires the transmission power information received in the transmitting/receiving section 103 by higher layer signaling. The acquisition section 111 has, for example, a table in which the bit information included in DCI and proportions of increased transmission power are associated with each other, and, with reference to this table, finds the proportion of increased transmission power from the bit to represent the transmission power information included in DCI of the downlink control signal.

The feedback information generating section 112 generates feedback information of CoMP cells included in the CoMP cell information reported from the radio base station apparatus, or feedback information of CoMP candidate cells included in the CoMP candidate cell information determined in the CoMP cell determining section 115, and feedback information of the serving cell. This feedback information is generated by performing channel estimation using reference signals (CSI-RSs (Channel State Information-Reference Signals) and CRSs (Cell-Specific Reference Signals)), and by calculating the CQI, PMI and RI using the channel estimation values. The feedback information generating section 112 outputs the feedback information to the transmitting/receiving section 103 and transmits this to the radio base station apparatus by the PUCCH.

The user data demodulation section 113 demodulates the user data received via the transmitting/receiving section 103. At this time, the user data demodulation section 113 demodulates the user data using user-specific DM-RSs. The user data demodulation section 113 demodulates user data from varying cells, in radio resource (RB) units, using information which indicates that DCS-CoMP is adopted (mode information). Note that the mode information may be output from the CoMP cell determining section 115 based on the decision result in the CoMP cell determining section 115, or may be reported from the radio base station apparatus.

The received power measurement section 114 measures the received power of the signal from the serving cell and the received power of signals from a plurality of neighboring cells, using the neighboring cell information reported from the radio base station apparatus. The received power measurement section 114 outputs the received power measurement results to the CoMP cell determining section 115.

The CoMP cell determining section 115 calculates the differences between the measurement result (received power) of the serving cell and the measurement results (received power) of the neighboring cells, compares the difference values with a predetermined threshold value, and determines neighboring cells where the difference value is equal to or lower than the predetermined threshold value as CoMP candidate cells. The CoMP cell determining section 115 outputs information about the CoMP candidate cells to the transmitting/receiving section 103. Also, when the first method is used, the CoMP cell determining section 115 recognizes that DCS-CoMP is adopted when there are CoMP candidate cells. Also, when the second method is used, the CoMP cell determining section 115 recognizes that DCS-CoMP is adopted when CoMP cells are reported. When recognizing that DCS-CoMP is adopted, the CoMP cell determining section 115 outputs mode information, which indicates DCS-CoMP is adopted, to the user data demodulation section 113.

Note that it is equally possible to measure the received power of the signal from the serving cell and the received power of the signals from a plurality of neighboring cells and furthermore calculate the differences between the measurement result (received power) of the serving cell and the measurement results (received power) of the neighboring cells in the received power measurement section 114, and compare the difference values with a predetermined threshold value and determines neighboring cells where the difference value is equal to or lower than the predetermined threshold value as CoMP candidate cells in the CoMP cell determining section 115.

In this way, in the radio communication system according to the present invention, when DCS-CoMP transmission is adopted, a radio base station apparatus increases transmission power in radio resources to transmit to a mobile terminal apparatus and transmits the increased transmission power to the mobile terminal apparatus as transmission power information, so that it is possible to further improve the received quality in the mobile terminal apparatus when CoMP—in particular, DCS-CoMP—is adopted.

Next, the radio communication method according to the present invention will be described.

(First Method)

First, from the radio base station apparatus (eNB) of the serving cell, information about neighboring cells (neighboring cell information) is reported semi-statically. Next, in the CoMP cell determining section 115 of a mobile terminal apparatus, CoMP candidate cells are specified using the neighboring cell information. To be more specific, the mobile terminal apparatus measures the received power of the signal from the serving cell and the received power of the signals from a plurality of neighboring cells in the received power measurement section 114, and calculates the differences between the measurement result (received power) of the serving cell and the measurement results (received power) of the neighboring cells, and specifies neighboring cells where that difference is equal to lower than a predetermined threshold value as CoMP candidate cells. The mobile terminal apparatus reports this CoMP candidate cell information to the radio base station apparatus of the serving cell by higher layer signaling or by the PDCCH.

Next, the mobile terminal apparatus generates feedback information (CQI, PMI, RI) (feedback information in CoMP mode), with respect to each specified CoMP candidate cell, in the feedback information generating section 112. The mobile terminal apparatus reports this feedback information to the radio base station apparatus of the serving cell by the PUCCH. When DCS-CoMP is adopted, the radio base station apparatus changes (increases) transmission power, in the transmission power changing section 212, as shown in FIG. 2B or FIG. 3B. When DCS-CoMP is adopted, transmission power information to indicate changes of transmission power is reported from the radio base station apparatus to the mobile terminal apparatus by higher layer signaling or by downlink control information.

(Second Method)

First, from the radio base station apparatus (eNB) of the serving cell, information about neighboring cells (neighboring cell information) is reported semi-statically. Next, a mobile terminal apparatus specifies CoMP candidate cells using the neighboring cell information in the CoMP cell determining section 115. To be more specific, the mobile terminal apparatus measures the received power of the signal from the serving cell and the received power of the signals from a plurality of neighboring cells in the received power measurement section 114, and calculates the differences between the measurement result (received power) of the serving cell and the measurement results (received power) of the neighboring cells, and specifies neighboring cells where that difference is equal to lower than a predetermined threshold value as CoMP candidate cells. The mobile terminal apparatus reports this CoMP candidate cell information to the radio base station apparatus of the serving cell by higher layer signaling or by the PDCCH.

Next, the radio base station apparatus determines CoMP cells from the CoMP candidate cell information reported, in the CoMP cell determining section 211. Then, the radio base station apparatus reports information about the CoMP cells (CoMP cell information) to the mobile terminal apparatus semi-statically. Next, in the feedback information generating section 112, the mobile terminal apparatus generates feedback information (CQI, PMI, RI) (feedback information in CoMP mode) for each reported CoMP cell. The mobile terminal apparatus reports this feedback information to the radio base station apparatus of the serving cell by the PUCCH. The radio base station apparatus changes (increases) transmission power, as shown in FIG. 2B or FIG. 3B, when DCS-CoMP is adopted. When DCS-CoMP is adopted, transmission power information to indicate changes of transmission power is reported from the radio base station apparatus to the mobile terminal apparatus by higher layer signaling or by downlink control information.

Although a case has been described with the above embodiment where transmission power information is included in DCI of downlink control signals, the present invention is by no means limited to this and is equally applicable to a case of including and reporting transmission power information in other channel signals.

Now, although the present invention has been described in detail with reference to the above embodiments, it should be obvious to a person skilled in the art that the present invention is by no means limited to the embodiments described in this specification. The present invention can be implemented with various corrections and in various modifications, without departing from the spirit and scope of the present invention defined by the recitations of the claims. Consequently, the descriptions in this specification are provided only for the purpose of explaining examples, and should by no means be construed to limit the present invention in any way.

The disclosure of Japanese Patent Application No. 2011-106413, filed on May 11, 2011, including the specification, drawings and abstract, is incorporated herein by reference in its entirety.

1. A radio base station apparatus comprising:
a power changing section configured to, when dynamic cell selection-type coordinated multiple-point transmission is adopted, increase transmission power in radio resources to transmit to a mobile terminal apparatus; and
a transmission section configured to transmit the increased transmission power to the mobile terminal apparatus as transmission power information, and also performs dynamic cell selection-type coordinated multiple-point transmission at the increased transmission power.

2. The radio base station apparatus according to claim 1, wherein the power changing section adds a proportion of transmission power of radio resources which are not transmitted to the mobile terminal apparatus or in which transmission power is reduced, to the radio resources to transmit to the mobile terminal apparatus.

3. The radio base station apparatus according to claim 1, further comprising a determining section configured to determine a CoMP cell from CoMP candidate cell information from the mobile terminal apparatus,
wherein the transmission section transmits the CoMP cell information to the mobile terminal apparatus.

4. The radio base station apparatus according to claim 1, wherein the transmission power information is transmitted to the mobile terminal apparatus by higher layer signaling.

5. The radio base station apparatus according to claim 1, wherein the transmission power information is transmitted by a downlink control signal (DCI).

6. A mobile terminal apparatus comprising:
a receiving section configured to, when dynamic cell selection-type coordinated multiple-point transmission is adopted, receive transmission power information representing the increased transmission power; and
a demodulation section configured to demodulate a signal received by dynamic cell selection-type coordinated multiple-point reception.

7. The mobile terminal apparatus according to claim 6, further comprising:
a measurement section configured to measure received power of neighboring cells reported from a serving cell; and
a determining section configured to determine a CoMP candidate cell from measurement results of the received power of the neighboring cells.

8. The mobile terminal apparatus according to claim 6, wherein the receiving section receives information about a CoMP cell from the radio base station apparatus.

9. The mobile terminal apparatus according to claim 8, further comprising a generating section configured to generate feedback information for the CoMP cell or the CoMP candidate cell.

10. A radio communication method comprising the steps of:
in a radio base station apparatus:
when dynamic cell selection-type coordinated multiple-point transmission is adopted, increasing transmission power in radio resources to transmit to a mobile terminal apparatus;
transmitting the increased transmission power to the mobile terminal apparatus as transmission power information; and
performing dynamic cell selection-type coordinated multiple-point transmission at the increased transmission power; and in the mobile terminal apparatus:
receiving the transmission power information; and
demodulating a signal received by dynamic cell selection-type coordinated multiple-point reception.

11. A radio communication system comprising:
a radio base station apparatus comprising:
a power changing section configured to, when dynamic cell selection-type coordinated multiple-point transmission is adopted, increase transmission power in radio resources to transmit to a mobile terminal apparatus; and
a transmission section configured to transmit the increased transmission power to the mobile terminal apparatus as transmission power information, and also perform dynamic cell selection-type coordinated multiple-point transmission at the increased transmission power; and
a mobile terminal apparatus comprising:
a receiving section configured to receive the transmission power information; and
a demodulation section configured to demodulate a signal received by dynamic cell selection-type coordinated multiple-point reception.

12. The radio communication system according to claim 11, wherein the power changing section adds a proportion of transmission power of radio resources which are not transmitted to the mobile terminal apparatus or in which transmission power is reduced, to the radio resources to transmit to the mobile terminal apparatus.

13. The radio communication system according to claim 11, wherein the radio base station apparatus further comprises a determining section configured to determine a CoMP cell from CoMP candidate cell information from the mobile terminal apparatus,
wherein the transmission section transmits the CoMP cell information to the mobile terminal apparatus.

14. The radio communication system according to claim 11, wherein the mobile terminal apparatus further comprises:
a measurement section configured to measure received power of neighboring cells reported from a serving cell; and
a determining section configured to determine a CoMP candidate cell from measurement results of the received power of the neighboring cells.

15. The mobile terminal apparatus according to claim 7, further comprising a generating section configured to generate feedback information for the CoMP cell or the CoMP candidate cell.
